(19) United States
(12) Patent Application Publication
(10) Pub. No.: US 2026/0280113 A1
(43) Pub. Date: Sep. 17, 2026

(54) RADIANT DEVICE FOR A FLAG-TYPE ADVERTISING SIGN AND ADVERTISING FLAG

(71) Applicant: Celling 5G Network, S.L., Madrid (ES)

(72) Inventors: Guillermo SAINZ FUERTES, Madrid (ES); Francisco Javier CORTÉS SANTAOLALLA, Zaragoza (ES); Ana Edelmira MERINO RUBIO, Zaragoza (ES)

(21) Appl. No.: 19/471,144

(22) PCT Filed: Apr. 3, 2023
(86) PCT No.: PCT/ES2023/070217

§ 371 Date: Sep. 30, 2025

(51) Int. Cl. H01Q 1/44; H01Q 1/12; H01Q 1/24; H01Q 5/25; H01Q 5/48; H01Q 25/00

(52) U.S. Cl. CPC H01Q 1/44; H01Q 1/1207; H01Q 1/1264; H01Q 1/246; H01Q 5/25; H01Q 5/48; H01Q 25/001

(57) ABSTRACT

The invention relates to a radiant device for an advertising flag-type sign (1) comprising two communications modules (2), wherein each one comprises a hybrid combiner (6) comprising two inputs intended to connect to microcells (7), and two outputs that generate signals at 0° and −90°; diplexers (5) connected to the hybrid combiner (6); dipoles (3, 4) connected to the diplexers and which work in the 4G and 5G frequency ranges, respectively; and a power supply module for the dipoles (3, 4). The device can also comprise two microcells (7) connected to the hybrid combiners (6). In addition, the invention relates to an advertising flag sign (1) comprising rotating supports on which the communications modules (2) are arranged which can rotate an azimuth angle of ±90°.

### OBJECT OF THE INVENTION

The object of the present invention is a radiant device for an advertising flag-type sign which allows the same to act as a microcell, or small cell, providing 4G and 5G coverage in a street furniture element. Moreover, an object of the invention is an advertising flag comprising a radiant device.

### BACKGROUND OF THE INVENTION

Currently, advertising signs or supports in a variety of forms are known in the state of the art, such as flags, monoliths, poles, etc.

Furthermore, in recent times, different electronic modules have been incorporated inside these advertising supports to provide them with different features, such as improved mobile coverage, Wi-Fi connection or providing inductive recharging of mobile devices.

With regard to improving coverage, 5G micro-antennas, or small cells, are incorporated into the advertising support, in order to provide the necessary coverage in urban centers, along highways or in rural areas that require said coverage.

Specifically, small cells are intermediate mobile access nodes. Small base stations, small both in size and in transmission power, are used to connect conventional mobile terminals to the networks of operators, generally using fixed broadband connections, such as ADSL, cable, or fibre-optic, and continue to use existing mobile network technology (for example, 4G or 5G). In this way, it is possible to download the mobile networks of operators and minimise saturations.

There are several types depending on the size of your coverage area. For example, femtocells, which have the smallest radius and are generally for home use, picocells, with a larger radius, used in business environments, or microcells, used in neighborhoods or large buildings.

The main idea of these devices is that it is not necessary to put a large and expensive mobile phone antenna near an area with poor coverage or where there are many users. All that is needed is this intermediate node and an operator's customers will be able to connect to it using the same mobile technology.

For this reason, it is of special interest to be able to incorporate these types of devices into advertising signs, which allows these micro-antennas to be introduced in urban environments. However, it is necessary to adapt the micro-antennas to the type of street furniture to which they couple, since it is important to maintain maximum efficiency for each type of structure.

### DESCRIPTION OF THE INVENTION

The object of the present invention is a radiant device for advertising flag-type street furniture that allows for coverage of 4G and 5G services in the frequency range between 1695 and 3800 MHz. Furthermore, an object of the invention is an advertising flag-type sign that comprises a radiant device that provides 4G and 5G coverage.

Firstly, the radiant device object of the invention comprises two communications modules, each one of which, in turn, comprises a 2×2 hybrid combiner that works in the 1695-3800 MHz range, which comprises two inputs, one or more of them intended to be connected to a microcell, and which further comprises two outputs, which generate a first signal polarised at 0° and a second signal polarised at −90°.

In addition, each communications module comprises a first diplexer, connected to the output signal polarised at 0° of the hybrid combiner and a second diplexer, connected to the output signal polarised at −90° of the second communications module, the former generating two signals polarised at +45° and the latter generating two signals polarised at −45°. Therefore, the diplexers separate the signal into the working ranges of 1695-2690 MHz and 3300-3800 MHz.

Connected to the first +45° output of the first diplexer and to the first −45° output of the second diplexer, each communications module comprises a first dipole that works in a frequency range between 1.69-2.7 GHz (4G).

Connected to the second +45° output of the first diplexer and to the second −45° output of the second diplexer, each communications module comprises a second dipole that works in a frequency range between 3.3-3.8 GHz (5G).

Lastly, each communications module comprises a power supply module for the dipoles, connected to the same.

The radiant device can further comprise one or more microcells, or small cells, preferably two, each one of which is connected to both hybrid combiners of the two communication modules. In this way, the hybrid combiners allow the dipoles to directly receive input signals from the microcells without the need for any other external combiner.

Therefore, the fact that each of the outputs of the hybrid combiner is directed to one of the microcells makes it so that, from each one of them, it is possible to provide coverage through both modules to the two microcells in the 4G (1695-2690 MHz) and 5G (3300-3800 MHz) frequency ranges.

Secondly, the object of the present invention is an advertising flag-type sign comprising two communications modules and two microcells, such as the ones previously described. The flag further comprises a vertical support intended to be arranged perpendicular to the ground, in which both communication modules are placed, one on top of the other. Specifically, the communications modules are fixed to the vertical support by means of rotating bases, which allow the communications modules to be independently adjustable an azimuth angle of ±90°, such that each of them covers a section of the sign, providing full coverage between the two of them.

Thus, two microcells from the same operator, working on different technology and frequencies, can be installed inside the flag-type advertising sign, or two microcells of different operators for location sharing, or a single microcell, in which case one connector of each module will remain free without affecting the operation of the radiant device.

### DESCRIPTION OF THE DRAWINGS

As a complement to the description and for the purpose of helping to better understand the features of the invention according to a preferred practical exemplary embodiment thereof, a set of drawings is attached as an integral part of said description in which the following is depicted in an illustrative and non-limiting manner:

FIG. 1.—Shows a general view of the communications modules coupled to the advertising flag-type sign.

FIG. 2.—Shows a schematic representation of the communication modules connected to the microcells.

FIG. 3.—Shows a detailed view of one of the communications modules.

### PREFERRED EMBODIMENT OF THE INVENTION

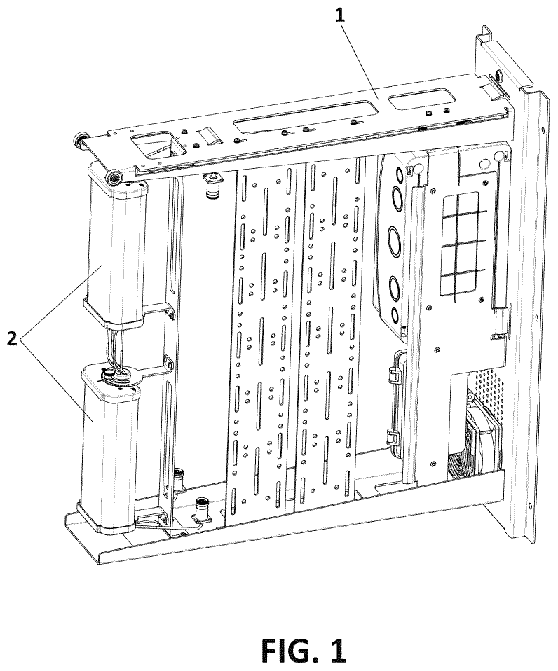

A preferred embodiment of the radiant device for an advertising flag-type sign (1), object of the present invention, as well as the advertising flag-type sign (1), is described below with the help of FIGS. 1 to 3.

A first object of the invention is an advertising flag-type sign (1) radiant device for street furniture that allows for the coverage of 4G and 5G services in the frequency range between 1695 and 3800 MHz (4G (1695-2690 MHz) and 5G (3300-3800 MHz)).

The radiant device, which is intended to be inserted inside an advertising flag-type sign (1), comprises two very small communications modules (2), as shown in FIG. 1.

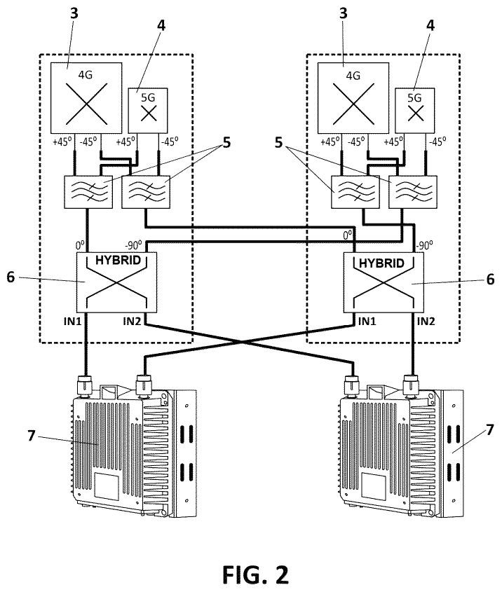

FIG. 2 shows a schematic representation of the communications modules (2), which, first, comprise a 2×2 hybrid combiner (6) that works in the 1695-3800 MHz range, comprising two inputs, one or more of which is intended to connect to a microcell (7), and which further comprises two outputs, which generate a first signal polarised at 0° and a second signal polarised at −90°.

In addition, each communications module (2) comprises a first diplexer (5), connected to the output signal polarised at 0° of the hybrid combiner (6) and a second diplexer (5), connected to the output signal polarised at 0° of the hybrid combiner (6) of the other communications module, the former generating two signals polarised at +45° and the latter generating two signals polarised at −45°. Therefore, the diplexers (5) split the signal into two working ranges of 1695-2690 MHz and 3300-3800 MHz.

With regard to the diplexers (5) of the second communications module (2), the first diplexer (5) is connected to the output signal polarised at −90° of the hybrid combiner (6) and the second diplexer (5) is connected to the output signal polarised at −90° of the hybrid combiner (6) of the other communications module (2).

Connected to the first +45° output of the first diplexer (5) and to the first −45° output of the second diplexer (5), each communications module (2) comprises a first dipole (3) that works in a frequency range between 1.69-2.7 GHz (4G).

Connected to the second +45° output of the first diplexer (5) and to the second −45° output of the second diplexer (5), each communications (2) module comprises a second dipole (4) that works in a frequency range between 3.3-3.8 GHz (5G).

Lastly, each communications module (2) comprises a power supply module for the dipoles (3, 4), connected to the same.

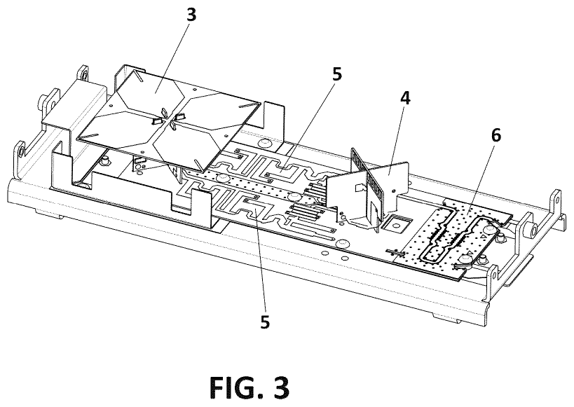

Due to the need to reduce the size of the communications modules (2), given that they are intended to be placed inside a small advertising sign (1) of approximately 700×700×150 mm, the dipoles (3, 4) are of the PCB (Printed Circuit Boards) type, as shown in FIG. 3.

With regard to the hybrid combiners (6), in a preferred embodiment of the invention, they must meet the following requirements:
85% bandwidth (1695-4200 MHz), minimum 77% (1695-3800 MHz),
adaptation (VSWR)<1.3,
isolation>20 dB, and
insertion loss=3.5±0.35 dB.

In addition to the two dipoles (3, 4), the hybrid combiners (6) are also printed on a PCB, as shown in FIG. 3.

Microstrip technology is used for the diplexers (5) and the power supply module. Specifically, to make the device as economical as possible, the hybrid combiners (6) are integrated into the same PCB using the same technology, or another that is compatible with the layer composition.

In particular, to implement the hybrid combiners (6), broadside combiners are used in tandem, implemented with double-layer microstrip technology. This makes it possible to absorb offset error tolerances when using diagonally offset coupled lines. In addition, the tandem configuration makes it possible to improve the final performance of the hybrid combiner (6).

When implementing the PCB, microstrip waveguide technology is used for the diplexers (5) and the power supply module, and coplanar waveguides for the hybrid couplers (6).

In one aspect of the invention, the radiant device also comprises two microcells (7), or small cells, each of which is connected to both hybrid combiners (6), as shown in FIG. 2, which allow the dipoles (3, 4) to receive the direct input of signals from the microcells (7) without the need for any other external combiner.

Therefore, the fact that each of the outputs of the hybrid combiner (6) is directed to one of the microcells (7) allows coverage by both modules to be provided from each of the same to the two microcells (7) in the 4G (1695-2690 MHz) and 5G (3300-3800 MHz) frequency ranges.

Furthermore, an object of the present invention is an advertising flag-type sign (1) comprising a radiant device such as the one described above. As shown in FIG. 1, each of the communications modules (2) of the radiant device are placed on a vertical support inside the advertising banner (1), one above the other, both being adjustable thanks to rotating supports, which fix them to the vertical support, thereby allowing the communication modules (2) to rotate with respect to the sign.

As the communications modules (2) are adjustable an azimuth angle of ±90°, each of them provides coverage to a section, providing coverage to the entire cell between them.

In addition, the communications modules (2) comprise embedded hybrid combiners (6), which reduces space, allowing two microcells (7) of the same operator working on a different technology and frequency to be installed inside an advertising flag-type sign (1), or two microcells (7) from different operators to share the location, or a single microcell, in which case one connector of each communications module (2) will remain free without affecting the operation of the radiant device.

1.—A radiant device for an advertising flag-type sign (1), characterised in that it comprises a first and second communications module (2), wherein the first communications module (2) comprises:
a 2×2 hybrid combiner (6) that works in a frequency range of 1695-3800 MHz, comprising two inputs, one or more of which is intended to connect to a microcell (7), and which comprise two outputs through which a first signal polarised at 0° and a second signal polarized at −90° are generated,
a first diplexer (5), connected to the output of the signal polarised at 0° of the hybrid combiner (6) and a second diplexer (5), connected to the output of the signal polarised at 0° of the hybrid combiner (6) of the second communications module (2), the first diplexer (5) generating two output signals polarised at +45 ° and the second diplexer (5) generating two output signals polarised at −45°,
a first dipole (3), connected to a first +45° output of the first diplexer (5) and to a first −45° output of the second diplexer (5), working in a frequency range between 1695-2690 MHz (4G),
a second dipole (4), connected to a second +45° output of the first diplexer (5) and to a second −45° output of the second diplexer (5), working in a frequency range between 3300-3800 MHz (5G),
a power module for the dipoles (3, 4), connected to the first and second dipoles (3, 4), and
the second communications module (2) being identical to the first communications module (2) but the first diplexer (5) being connected to the output of the signal polarised at −90° of the hybrid combiner (6) thereof and the second diplexer connected to the output of the signal polarised at −90° of the hybrid combiner (6) of the first communications module (2).

2.—The device of claim 1, wherein the dipoles (3, 4) are the PCB (Printed Circuit Boards) type.

3.—The device of claim 1, wherein the hybrid combiners (6) meet the following requirements:
85% bandwidth (1695-4200 MHz),
adaptation (VSWR)<1.3,
isolation>20 dB, and
insertion loss=3.5±0.35 dB.

4.—The device of claim 1, wherein the hybrid combiners (6) are the PCB type.

5.—The device of claim 1, wherein the diplexers (5) and the power supply module are microstrips.

6.—The device of claim 5, wherein the hybrid combiners (6) are the broadside type in tandem.

7.—The device of claim 1, further comprising at least one microcell (7) connected to both hybrid combiners (6).

8.—The device of claim 1, comprising two microcells (7) each one of which is connected to both hybrid combiners (6).

9.—An advertising flag-type sign (1) comprising a radiant device such as the one described in any of the preceding claims, characterised in that it comprises:
an inner hollow receptacle,
a vertical support located in the receptacle,
rotating supports fixed to the vertical support, to which the communications modules (2) are coupled, being able to rotate an azimuth angle of ±90°.
